(19) United States
(12) Patent Application Publication
(10) Pub. No.: US 2007/0282730 A1
(43) Pub. Date: Dec. 6, 2007

(54) Consolidation, sharing and analysis of investment information

(76) Inventors: Steven A. Carpenter, San Francisco, CA (US); Douglas E. Reed, San Francisco, CA (US); Sven Junkergard, San Francisco, CA (US)

Correspondence Address: COURTNEY STANIFORD & GREGORY LLP, P.O. BOX 9686, SAN JOSE, CA, 95157, US

(21) Appl. No.: 11/796,977

(22) Filed: Apr. 30, 2007

Related U.S. Application Data
(60) Provisional application No. 60/796,756, filed on May 1, 2006.

(51) Int. Cl. G06Q 40/00; G06F 17/18

(52) U.S. Cl. 705/36 R

(57) ABSTRACT

Systems and methods are described for gathering investment information of peers and/or other trusted sources and making the investment information and analysis available on a real-time basis. These systems and methods provide investment information and advisory services for individual members generated through peer research, real-time portfolio and trading sharing. Individual member account data is consolidated from a variety of data sources, and members are allowed to share the aggregate data set for the purposes of providing real-time information, insights, and investment recommendations to peers based upon individual performance, real-time trading activity, and summary member data.

### RELATED APPLICATION

This application claims the benefit of U.S. Patent Application No. 60/796,756, filed May 1, 2006.

### TECHNICAL FIELD

The disclosure herein relates generally to information systems. In particular, this disclosure relates to gathering and sharing investment and trade data.

### BACKGROUND

Currently, individual investor data and the actual performance of individual investor returns are not transparent. There also is no platform that allows for the formal sharing of actual/authenticated/verifiable individual investment information with others. As a consequence, the entire $100 B investment advisory and portfolio management industry and $10 T mutual fund industry have preyed upon investor insecurity and confusion. The lack of a universal standardized set of benchmarks for independent advisors, investment managers, and mutual fund managers has resulted in billions of dollars in wasted fees annually as individuals fail to meet basic return metrics. Coupled with the popping of the Internet investment bubble, corporate scandals, Wall Street analyst conflicts of interests, etc. many individuals no longer trust professional financial service providers and instead rely on friends and family when making their investment decisions.

Consumer research indicates that friends and family are the most trusted source for investment information and that people by and large do not trust professionals for advice. There are now more than 35 MM active online brokerage accounts and 40 MM American investors who do not rely on a financial advisor to make their important investment decisions. And, those who do so are becoming more and more involved in managing their advisors' decisions. With nearly 75% of mutual funds underperforming their respective indices after accounting for fees, individual investors would have been better off over the past twenty years buying the stocks of the fund companies themselves rather than consuming their services. More, new research out of Harvard Business School suggests that the top decile of individual investors consistently beat the market by 4 basis points per day, or 10% annually. It is no wonder that the Annual Securities Industry Association Investor Survey found that nearly 70% of surveyed investors believe “financial advisors and advisory firms put their own interests ahead of their clients.” This sentiment has been steadily and consistently rising since 1999.

There is also strong empirical evidence that suggest that the collective decision-making of a group of individuals making guesses about a subject that can be quantified, often best “expert” sentiment. In the book “The Wisdom of Crowds” by James Surowiecki, the author provides many examples that support this theory. The famous example is the finding that the average of a collective of guesses of the number of jellybeans in a jar comes very close to the actual number; a better guess than the single best guesses individually. As this relates to the stock market, Wharton professor J. Scott Armstrong wrote that he “could find no studies that showed an important advantage for expertise” over individuals. Marshall Wace, a $10 B hedge fund based in the UK, has created a proprietary system, called TOPS, to take advantage of this reality. The firm has created a platform for 1,500 brokers around the world to send in their best investment ideas, which Marshall Wace then runs through its proprietary algorithms. Marshall Wace has been one of the top performing hedge funds in the world over the past few years, relying on these collective ideas. Last, Internet startup PicksPal (www.pickspal.com), a website that allows its users to guess the outcome of sporting events, has uncovered a similar outperformance by a group of its top pickers. PicksPal's overall record against Las Vegas betting lines has been 562-338, a win rate of 63%. In college basketball, the win rate is 66%. In pro football, the win rate is 62%. They are even getting a 52% win rate in pro hockey. In other words, the collective guesses of its top users are besting betting markets.

Consequently, there is a need for a system that will eliminate the uncertainty and intimidation around personal investments by automating and formalizing the current practice of shared peer investment advice with actual, actionable, real-time data. Conventional systems used in the investment business have not yet specifically addressed these consumer needs around investment data but there are a few similar and related technologies and services that have focused on aggregating data principally for viewing.

For example, the Open Financial Exchange (OFX) Standard is a specification for the electronic exchange of financial data between financial institutions, business and consumers via the Internet. Created by CheckFree, Intuit and Microsoft in early 1997, Open Financial Exchange supports a wide range of financial activities including consumer and small business banking, consumer and small business bill payment, bill presentment, tax information, and investments tracking, including stocks, bonds, mutual funds, and 401(k) account details. Open Financial Exchange defines how financial services companies can exchange financial data over the Internet with the users of transactional Web sites, thin clients and personal financial software. Open Financial Exchange streamlines the process financial institutions need to connect to multiple customer interfaces, processors and systems integrators. The Open Financial Exchange specification is publicly available for implementation by any financial institution or vendor. As of March 2004 OFX is supported by over 2,000 banks and brokerages as well as major payroll processing companies.

Other examples of conventional systems include Quicken and Microsoft Money. These systems are Personal Financial Management software that allow users to download and view their financial information from a variety of accounts. For example, Quicken provides access to approximately 2,900 participating financial institutions. Both Quicken and Money allow a user to enter in their username and passwords and automatically download transaction and balance information from those accounts. Further, many of these financial institutions allow users to download “Web Connect” data directly from their sites to users' hard drives for importation later.

As yet another example of a conventional system, Yodlee provides personalized consumer financial solutions to banks, brokerages, and portals. Operating predominantly as an Application Service Provider (ASP), Yodlee has integrated with, and provides services for AOL, Bank of America, Charles Schwab, Chase, Fidelity, Merrill Lynch, MSN, and Wachovia. The Yodlee solutions are powered by a technology known as Account Aggregation, which is built into the Yodlee Platform. This Platform now powers financial service offerings for over 100 financial service providers (FSPs) and their more than 6 million consumers, processing millions of account updates daily in a highly secure, scalable, reliable way.

These examples show that conventional systems used in the investment business have not yet specifically addressed consumer needs around investment data. Consequently, there is a need for a system that helps the now 90 MM and growing individual investors in the U.S. make better, smarter, and more efficient investment decisions with their $16 T in investable assets using the collective knowledge and actual performance of their peers.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram of the investment data sharing system (IDSS), under an embodiment.

FIG. 2 is a flow diagram for rating securities using the IDSS, under an embodiment.

FIG. 3 is a block diagram of the aggregation component of the IDSS coupled to and/or including a normalizing component, under an embodiment.

FIG. 4 is a block diagram of the aggregation component of the IDSS coupled to a ranking component that outputs investor ranks, under an embodiment.

FIG. 5 is a flow diagram for ranking investors using the ranking component, under an embodiment.

FIG. 6 is a block diagram of the rating component of the IDSS configured to provide or output security ratings, under an embodiment.

FIG. 7 is a flow diagram for rating equities using the rating component operating on rank data and real-time trade data, under an embodiment.

FIG. 8 is a strength of signal plot, under an embodiment.

FIG. 9 is a block diagram of the recommendation component of the IDSS coupled to produce security rankings and dispense portfolio information or data, under an embodiment.

FIG. 10 is a flow diagram for investor matching using the IDSS, under an embodiment.

### DETAILED DESCRIPTION

Systems and methods are described below for gathering investment information of peers and/or other trusted sources and making the investment information and analysis available on a real-time basis. These systems and methods, collectively referred to herein as the investment data sharing system (IDSS), are configured and function to provide investment information and advisory services for individual member-investors (referred to as members, user, or subscribers) generated through peer research, real-time portfolio and trading sharing. The IDSS components are configured to consolidate individual member account data from a variety of data sources and then allow those members to share the aggregate data set for the purposes of providing real-time information, insights, and investment recommendations to peers based upon individual performance, real-time trading activity, and summary member data. Specifically, members will be able to share current holdings, positions that they are watching or thinking about buying or selling, and provide real-time or near real-time notifications of actual transactions. Furthermore, the IDSS generates insights into individual member portfolios based on the performance of other individual investors.

The IDSS include components configured to enable or support the collection and sharing of actual investment information among various individual member-investors. The investment data includes data of any type of investment vehicle used by the investor including but not limited to data or information of public equities or securities, exchange-traded funds (ETFs), mutual funds, fixed income and options data. In so doing, the IDSS aggregates investment data of members to form a data set that ties historical performance data of actual investors to real-time trade data. Aggregation of investment data, which includes data on what investments are being made and/or considered by members, includes pulling, fetching and/or receiving financial data from the members' brokerage accounts or other investment accounts and/or receiving data entered directly by a member. The IDSS uses the aggregate data to make inferences and conclusions on the overall market and then directly applies the inferences and conclusions to member portfolios. Thus, the IDSS creates a social network around investment information so that a member can gain access to investment data and performance of other members to whom the member is linked. Further, the IDSS provides an automated portfolio management system or service for use in financial or investment services that uses the aggregate data to provide cost effective yet customized investment advice.

The IDSS uses data of members to provide transparency and insights around current holdings, asset allocation, historical performance, risk assessment, watch list, research and trading activity of the members. Top performers become “stars” under the IDSS by helping others simply by allowing others access to their investment data. Investment performance is a unique data set because it is an objective metric; so-called “professionals” and “amateurs” can be judged on an even playing field. Once there is a community (the IDSS community) sharing this information, the aggregate data set is an incredibly powerful tool used to identify both high and low performing investors, which may likely exist in the close personal network of members. The IDSS thus reduces or eliminates the uncertainty and intimidation around personal investments by automating and formalizing the current practice of shared investment advice with actual, actionable, real-time data from peers.

In the following description, numerous specific details are introduced to provide a thorough understanding of, and enabling description for, embodiments of the IDSS. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

The following terms are intended to have the following general meanings as they are used herein.

An “investor” is any party that makes an investment. An investor in finance includes the particular types of people and companies that regularly purchase equity or debt securities for financial gain in exchange for funding an expanding company. An investor can purchase and hold assets in hopes of achieving capital gain, as a profession, and/or for short-term income.

A “security exchange” or share market is a corporation or mutual organization that provides facilities for stock brokers and traders, to trade company stocks and other securities. Stock exchanges also provide facilities for the issue and redemption of securities as well as other financial instruments and capital events including the payment of income and dividends. The securities traded on a security exchange include shares issued by companies, unit trusts and other pooled investment products and bonds. Trading or transactions via a security exchange can be via electronic networks and/or at a physical location.

A “market service” is a real-time, streaming quote and news service with data direct from stock exchanges. Market service data allows a member to watch market movements in real time. Examples of data or information available from a market service include, but are not limited to, the following: stock and option quotes; futures, futures options, and futures spreads quotes for international and domestic; international and domestic futures quotes; single stock futures quotes; customized watchlists; graphical displays and/or statistics of trading trends; tickers; and news of business, technology, commodities, and finance.

The description and examples of the IDSS that follow reference “securities” as the investment vehicle. The use of a single type of investment (“securities”) is only for purposes of simplicity in describing the system, and it is understood that “securities” can be replaced throughout the description herein with any type of investment vehicle used by investors. More specifically, for example, the investment vehicles contemplated hereunder include public equities, exchange-traded funds (ETFs), mutual funds, and fixed income and options data, to name a few, and can further include any other type of investment vehicle not specifically described herein that is appropriate under the description of the IDSS.

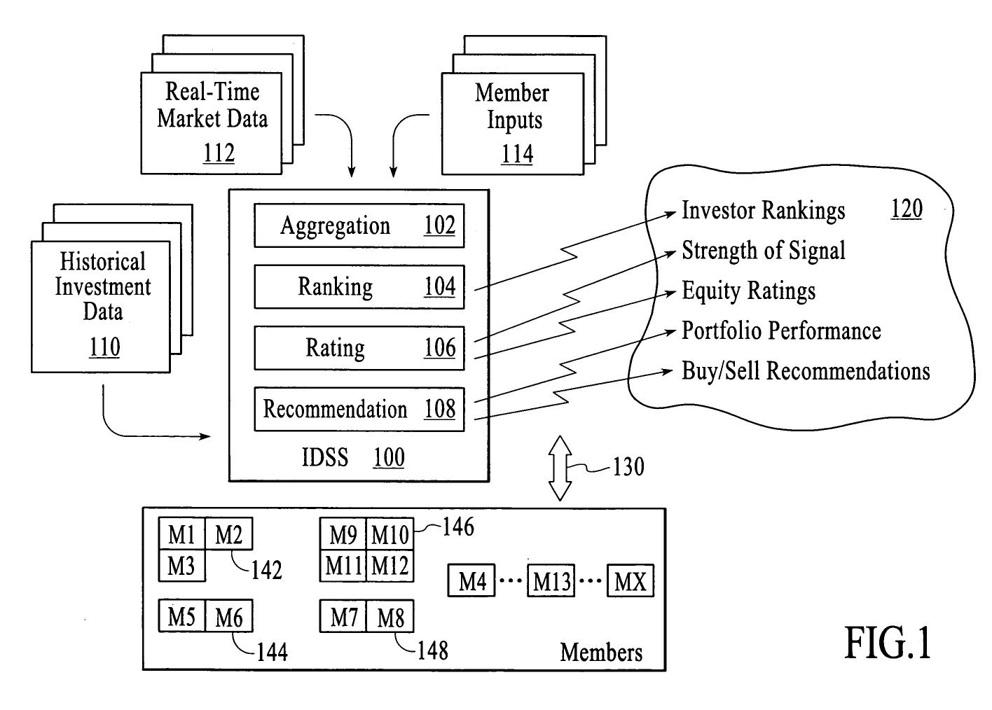

FIG. 1 is a block diagram of the investment data sharing system (IDSS) 100, under an embodiment. The IDSS includes numerous components running under one or more processors. The IDSS components of an embodiment include an aggregation component or engine 102, a ranking component or engine 104, a rating component or engine 106, and a recommendation component or engine 108. The IDSS includes couplings or connections to sources or components from which historical investment data 110 and real-time market data 112 can be received, fetched, gathered, and/or inputted. The investment data 110 and real-time market data 112 can be received periodically or continuously in real-time or near real-time via synchronization over electronic couplings with brokerages, market services, and/or other third-party sources of data. The IDSS is also configured to receive data or information 114 manually entered by a member.

The IDSS components 102-108 can be components of a single system, multiple systems, and/or geographically separate systems. The IDSS components 102-108 can also be subcomponents or subsystems of a single system, multiple systems, and/or geographically separate systems. The IDSS components 102-108 can be coupled to one or more other components (not shown) of a host system or a system coupled to the host system.

The IDSS components are configured and function, individually and/or collectively, to provide data products or outputs 120 including investor rankings, security ratings, risk-adjusted portfolio performance, and/or buy/sell recommendations, as described in detail below. The IDSS also includes portals and/or couplings 130 by which members M1-MX (where X is any number) can access the data products relating to their individual accounts or portfolios as well as the accounts or portfolios of members to whom they are linked. The portals and/or couplings 130 of an embodiment include, for example, connections between a member's computer and the IDSS via a web site provided or hosted by the IDSS.

Member access to the IDSS 100 includes links to the accounts and/or portfolios of other members and, consequently, the establishment of social networks 142-148 around investment information. Therefore, the IDSS components are configured to enable a member “invited” by a friend and/or family member (e.g., via electronic mail) to enter the IDSS and to establish a connection with the inviting member for the purposes of sharing investment information. Members are then able to establish and maintain connections with other peers within the IDSS for the purposes of sharing research, insights, portfolio investments, historical returns. The example shown includes four networks including: a first network 142 including linked members M1, M2 and M3; a second network 144 including linked members M5 and M6; a third network 146 including linked members M9, M10, M11, and M12; and a fourth network 148 including linked members M7 and M8. The example shown also includes numerous members M4 and M13-MX not linked to any other member. While particular networks are shown for purposes of this example, the embodiment is not limited to particular numbers or sizes of networks.

Operations under the IDSS generally include the flow or transfer of data in real-time or near real-time from third-party sources, generation of performance feedback and customized recommendations, and the establishment of a social network among member-investors that enables sharing of the data, performance feedback, and recommendations. Accordingly, the IDSS operations include the flow or transfer of data (e.g., historical investment data, real-time trade data, etc.) into the system, manipulations and calculations relating to the data, creating or establishing social networks around investment information, generating security ratings, generating security recommendations, providing sharing of research and investment information that includes members or a collection of members “following” portfolios, providing real-time trading notifications, and automatically performing trades based on system information, to name a few. Each of these operations is described below; these operational descriptions are provided as examples only and are not intended to limit embodiments of IDSS to those described.

The IDSS of an embodiment includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, cellular telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of the IDSS, and/or provided by some combination of algorithms. The IDSS methods described herein can be implemented in one or more of software algorithm(s), programs, firmware, hardware, components, circuitry, in any combination.

The IDSS components can be located together or in separate locations. Communication paths couple the IDSS components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

The IDSS 100 of an embodiment includes a ranking component 104, a security rating component 106, and a recommendation component 108, as described in detail herein. The basis for the ranking, rating and recommendation components or models of an embodiment is the fundamental assumption that historical out-performance by certain individual investors will, on average, lead to corresponding out-performance in the future for some determined amount of time. For example, see Coval, Joshua D., David Hirshleifer, and Tyler Shumway, “Can Individual Investors Beat the Market?” Harvard Business School Working Paper, No. 04-025, 2003). Thus, the “top” investors as designated by the IDSS, and based on a multitude of variables regarding past performance, current holdings, and real-time trading activity, will pick stocks that, on average, will outperform other investors, indices of non-active investment strategies, and professional investment advisors for some period of time. And, conversely, historically poorer performing individuals will select stocks that, on average, will under-perform these same benchmarks for another period of time. By also combining this data with publicly-available financial and trading information, the IDSS provides a compelling proprietary quantitative investment model that can be used to provide advice to anyone managing a portfolio.

Conventional rating systems rate stocks using a model based on some number of variables or criteria (e.g., related to earnings per share, market CAP, etc.), where the variables are all based on publicly available data or metrics. Once rated, the stocks are ranked. In contrast to these conventional systems, the IDSS rating component is built on a ranking system which ranks members or individuals. The IDSS generally uses a ranking component to rank members based on their historical investment performance, and then uses data of the ranking to identify a segment or portion of the people whose past performance is a good predictor of future results. The IDSS of an embodiment uses the aggregated data to rank the members and, using the ranking, identify the appropriate segment of people to use as predictors. Subsequently, the IDSS uses data of the real-time trading activities of the predictor members as a security rating system to rate securities for all participating members. Also, other parameters (e.g., earnings per share (EPS), price-to-earnings (P/E) ratio, stock price momentum, etc.) may be used along with the rank data to generate the security ratings. The rating system (e.g., ratings include A, B, C, D, and F ratings) is then used to automatically monitor member portfolios.

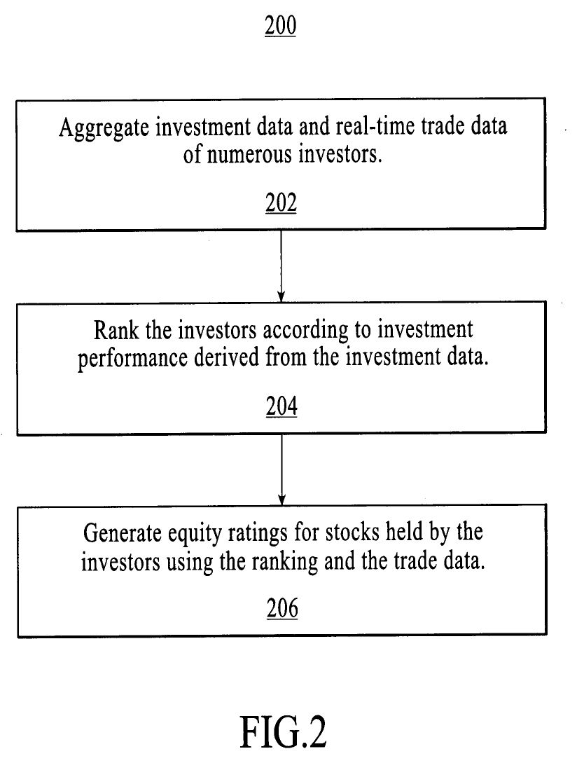

FIG. 2 is a flow diagram for rating securities 200, under an embodiment. The components of the IDSS 100 (FIG. 1) are configured to rate securities by aggregating 202 investment data and real-time trade data of numerous members. The investment data includes data of current holdings, historical holdings, historical performance data, historical transactional data, and/or watch lists, to name a few. More specifically, for example, the investment data includes data or information of public equities, exchange-traded funds (ETFs), mutual funds, fixed income and options data, but is not so limited and can include data of any type of investment vehicle used by the investor. The real-time trade data includes trade data of the members and publicly available trade data of at least one stock market. The IDSS components rank 204 the members according to investment performance derived from the investment data. Ratings are generated 206 for securities held by the members using the rankings along with the real-time trade data of the members. The IDSS compares the ratings with a member's current holdings and specified or calculated risk level and, in response, generates recommendations for the securities held by the member in his/her portfolio with the goal of providing a better performing mix of investments, while maintaining or lower the current risk level and preserving the investor's asset allocation strategy. The recommendations of an embodiment include a transaction recommendation and strength of signal indicator. The transaction recommendation includes a buy/sell rating for a corresponding stock, and the strength of signal indicator indicates strength of the transaction recommendation.

The data aggregation of an embodiment operates on data entered by a member and/or data received at the IDSS via data pushing, pulling, and/or fetching operations from the member's brokerage accounts or other investment accounts and/or receiving data entered directly by a member. For manual inputting of data by a member, the member can manually enter a portion and/or all of the positions of his/her portfolio data into the IDSS via a member portal or access point.

The IDSS also supports automatic data transfer operations. For example, a user can enter the username and password to each financial institution account (e.g., third-party brokerage account, etc.) that stores the member's online investment data; components of the IDSS will then receive the data from the third-party financial institution account via one or more of data pushing, pulling, fetching and/or retrieving operations. The data of an embodiment is automatically received according to programmable or selectable periods (e.g., hourly, twice a day, daily, weekly, etc.). Furthermore, the IDSS can import data from a file obtained from a third-party financial institution in response to activation or selection of a “download” button (e.g., “Quicken Web Connect”). Regardless of the data entry mechanism used, the IDSS components automatically aggregate investment data and incorporate the data into back-end databases with other individual investor data.

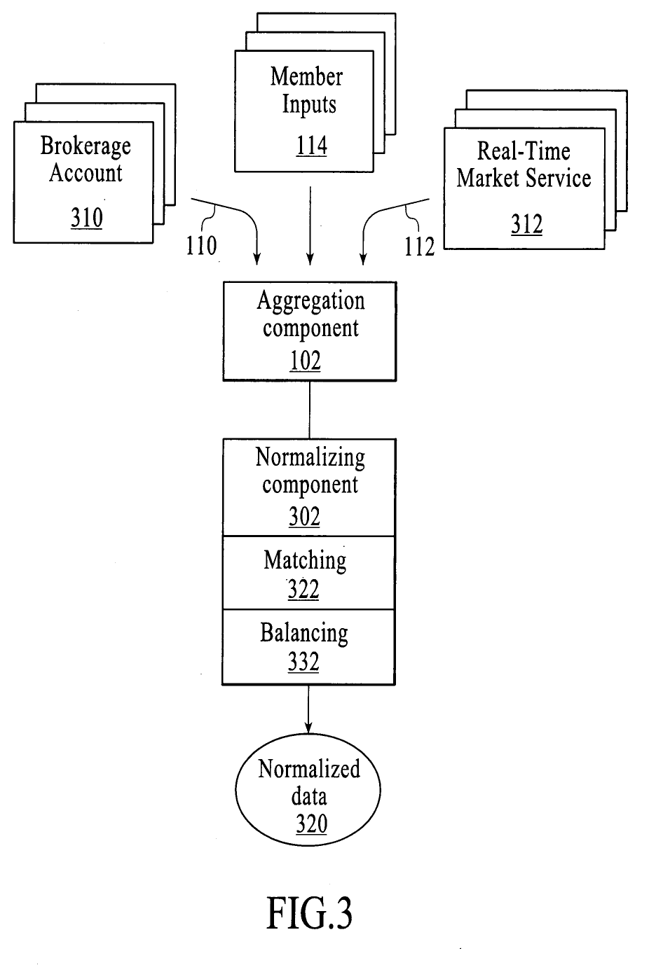

The data aggregation of an embodiment includes normalizing of data received at the IDSS. FIG. 3 is a block diagram of the aggregation component 102 of the IDSS coupled to a normalizing component 302, under an embodiment. The normalizing component 302 is coupled to the aggregation component 102 or, alternatively, integrated as a sub-component or sub-system of the aggregation component 102. The output of the normalizing component includes normalized data 320.

Using the normalizing component 302, data aggregation of an embodiment includes normalization of data aggregated from across multiple financial institution accounts. This normalization can include, but is not limited to insertion of synthetic buy/sell transactions for balancing purposes, determining if a portfolio is complete and balanced, auto reconciliation of positions and transactions, security matching given symbol, Committee on Uniform Security Identification Procedures (CUSIP) number, or company name, sector information, corporate action and short selling handling, and verification of position pricing information with several different historical data sources.

The IDSS of an embodiment is configured to normalize aggregated data by receiving investment data 110 (e.g., positions, transactions, cash balances, etc.) from one or more third-party brokerages 310 or brokerage accounts. The investment data 110 can be received via synchronization over electronic couplings with brokerages, market services, and/or other third-party sources of data. The received data is matched 322 against a known set of identifiers for each particular security. The matching 322 includes taking a set of possible solutions and finding the first successful match using the security's CUSIP, symbol, or name. Because every brokerage 310 may use a different description for broker actions, a determination is made as to how each brokerage 310 describes the common broker actions, for example, buy, sell, split, and dividend to name a few. Each transaction is then classified according to the broker action.

When the normalizing includes balancing 332, the IDSS of an embodiment is configured to balance 332 a portfolio by forming historical snapshots of the portfolio using data of the received positions and transactions. The snapshots are historical versions of a member's holdings and transactions at each transactional event. These snapshots include holdings coming into the transaction, holdings going out of the transaction, and a transactional event.

A determination is made as to whether any additional transactions are required in order to match 332 the current portfolio state or holding to the portfolio state indicated by the transactional history. If the transactional history totals to more holdings than the current portfolio holdings, the normalizing component 302 generates or creates a synthetic sell transaction to reduce the holdings; the synthetic sell transaction involves a number and/or type of stocks by which the transactions history exceeds the current holdings. If the transactional history totals to fewer holdings than the current portfolio holdings, the normalizing component 302 generates or creates a synthetic buy transaction to increase the holdings; the synthetic buy transaction involves a number and/or type of stocks by which the transactions history is deficient relative to the current holdings.

When the normalizing of an embodiment includes automatic reconciliation of positions and transactions, the IDSS is configured to locate a particular security. If the particular security is not located it remains in a “not found” state in the aggregate investment data. When located, the price, activity date, and action of the security is compared against all other transactions known for this member. If no other similar transactions are found for this member, the transaction is reconciled; otherwise, the transaction is marked as a possible duplicate transaction.

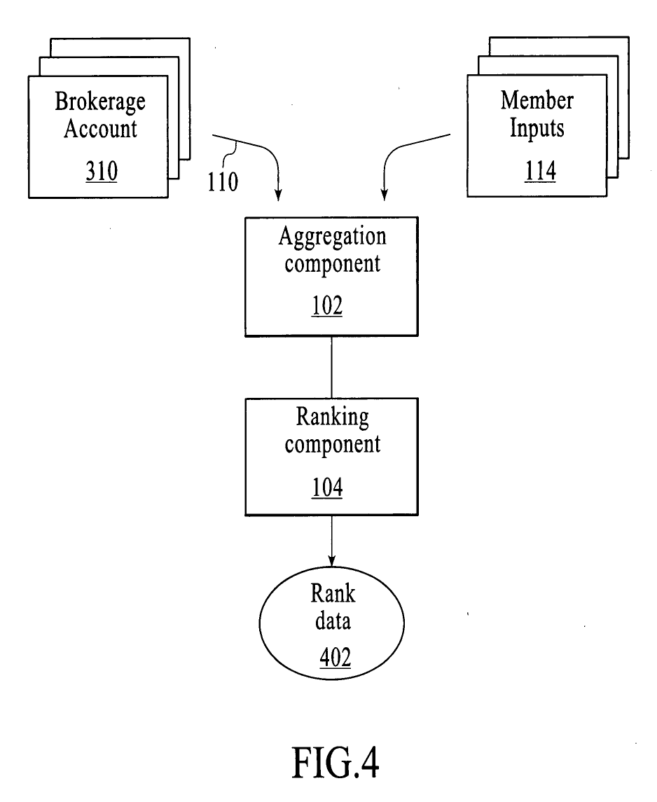

The IDSS uses aggregated data of investors to rank the investors. FIG. 4 is a block diagram of the aggregation component 102 of the IDSS coupled to a ranking component 104 that outputs investor ranks 402, under an embodiment. The input to the ranking component 104 includes normalized data as described above, but is not limited to normalized data.

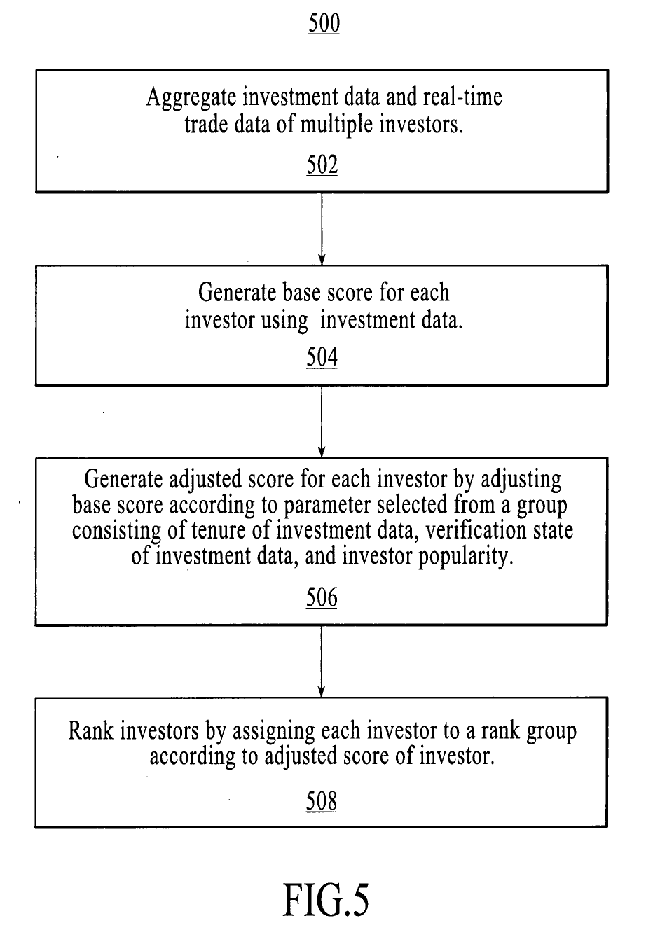

FIG. 5 is a flow diagram for ranking investors 500 using the ranking component 104, under an embodiment. Components of the IDSS are generally configured and function to aggregate 502 investment data and real-time trade data of the investors, as described above. A base score is generated 504 for each investor using the investment data. The investment data is received from third-party sources 310 and/or entered 114 by the member, as described above. An adjusted score is generated 506 for each investor by adjusting the base score according to an attribute or weighting parameter. The attribute can include, for example, tenure of the investment data, verification state of the investment data, and/or popularity of the investor to name a few. The IDSS ranks investors 508 by assigning each investor to a rank group according to the adjusted score of the investor. The ranking is described in detail below.

The IDSS ranks individual members based on a variety of attributes, including actual historical and current portfolio data. The ranking attributes might include data of watch lists but is not so limited. The security rating and recommendation engine operations are based on these rankings as detailed below. The ranking component generally ranks individual investors into different tiers, and the tiers are defined by different percentiles where the highest tier (e.g., Elite rank or tier) comprises the top investors in the IDSS community. The other tiers below the highest tier follow the same principle with the last tier comprising the lowest performing investors. The ranking is derived primarily from risk adjusted performance which is a measure of investor performance with the volatility attributable to different risk profiles removed and exposing the skill in picking different investments. Investors with a high risk adjusted performance are rated higher than those with a low risk adjusted performance.

The IDSS receives investment data of a large number of members, and the investment data includes actual historical portfolio data, current holdings, watch lists, and/or real-time trading information for example. The investment data can include other types of historical performance data of the members. This investment data is received into the IDSS from a variety of sources: online brokerage accounts, portfolio management websites, personal software of a member (e.g., Quicken, etc.), as well as manual entry. The investment data is received via importation, fetching, and/or retrieving, for example, or via other techniques known in the art for transferring data. The investment data received can span long periods of time and, in some cases, can go as far back as eight (8) years, depending on the data tenure of the online brokerages.

This disparate individual historical performance data in the system provides insight into the past and current universal distribution curve of “high” (strong) and “low” (poor) performing individual investors. Investors that have consistently experienced significant historical returns and outperformed indices and benchmarks are ranked higher than those with minimal or negative returns. For the first time, the IDSS enables individual investors to see where they stand as far as their investment performance relative to some number of their peers, and the top individual investors in the IDSS community can be recognized.

The ranking operations begin when a user imports his/her investment data from one or more brokerage accounts (e.g., Charles Schwab, Fidelity, eTrade, etc.) via an electronic coupling between the brokerage account and the IDSS. The IDSS aggregates the investment data received and initiates or performs a series of calculations. The data aggregation enables matching of investors as described herein, where the matching includes identifying other investors with portfolios having a similar structure to a member yet are realizing better performance than the member's portfolio.

The IDSS is configured to take the investment data and construct numerous distinct views of information. For example, the IDSS of an embodiment generates a first view that is personal to the member (personal view), a second view that is shared with a network (network view), and a third view that is shared with the general public (public view). The information views can be accessed via the IDSS web site. For the member specifically, the IDSS automatically calculates individual portfolio returns and performance for various time periods. The returns and performance are calculated, for example, for a current period (e.g., current day, time period of the current day, etc.) and/or during a historical period (e.g., daily for the last 180 days, daily for the last month, daily for the last quarter, daily for the last year, monthly for the last year, monthly for the last five (5) years, average annual return for the last year, average annual return for the last two (2) years, etc.).

The calculations performed by the IDSS of an embodiment include one or more of time or money weighted performance, current and historical portfolio risk, Sharpe ratio, portfolio dollar values (including cash balances), verification level of the “quality” of the data, number of trades/year, average hold time of an asset, average cost basis, holdings percentages and asset allocation, and tenure of data. These calculations appear on the member's area of a portal or electronic site (e.g., “members home page” of the IDSS web site) and are easily accessible throughout the IDSS. These calculations form the basis for a member statistics or “stats” area, which provides or preserves a historical record of a member's investment activity, similar to the statistics for a baseball player on the back of a baseball card. This is of immense value to a member since the majority of online brokerage firms only preserve a certain window of data and then it becomes inaccessible to the user as well as providing a consolidated view of the statistics for a member's entire holdings across various investment accounts held at different financial institutions.

The ranking component 104 of an embodiment is configured to perform a weighting of members using results of the calculations and data of numerous weighting parameters or member attributes as described above. The parameters include the risk-adjusted performance of each member. The risk-adjusted performance is generated from data of historical performance and risk.

The parameters also include the tenure of data. The tenure of data is the amount or length of transactional history available for a member. If a member has three years of transactional history stored within the system, the tenure of her account is three years, for example. The data tenure of an embodiment can be any period of time (e.g., 1-months data, 2 years of data, etc.).

The parameters additionally include validity of data. Each member has a verification level assigned to him/her based on the amount of that member's data that is manually created or entered by the member (e.g., not verifiable) and the amount of that member's data received via an electronic link or coupling with a brokerage (e.g. verifiable).

The ranking system weighting parameters can also include member popularity. The popularity attribute quantifies or weights each member by the quality of investors to which that member is linked on the platform. Members can follow other members, and when many other members are linked to a particular member (e.g., has many followers) this is a quantifiable measure of popularity. When considering a member's “popularity” the quality of the member's followers is also considered, and highly rated followers score higher than lowly rated followers.

The parameters for weighting of members further include momentum. The momentum attribute represents, for example, performance above a pre-specified threshold during a pre-specified period of time (e.g., 3 months, 6 months, etc.). The most recent performance trend (e.g., upward trend, downward trend, plateau) of the member's portfolio is therefore represented in the overall ranking as members can change their investment strategy at any point and the “current” strategy is more important to the IDSS member-investor community as it will be controlling the future performance of the investor.

The weighting parameters used in the ranking of members can include various other variables. The other variables can include number of trades per year by a member, average hold time of an investment, and sector weighting to name a few.

Using the weighting parameters described above, the IDSS “ranks” each member in order to compare him/her against other members, individuals, and benchmarks. In ranking each member, the ranking component 104 calculates or generates each member's five (5) year Sharpe Ratio, and this Sharpe Ratio forms a base score. While the ranking component 104 of an embodiment uses the Sharpe Ratio to form the base score, the embodiment is not so limited, and alternative embodiments can use other available techniques to generate the base score.

The ranking component 104 adjusts the base score according to one or more criteria. The ranking component 104 of an embodiment adjusts the base score according to the data tenure. For example, the base score remains unadjusted for a data tenure approximately equal to five (5) or more years, while the base score is adjusted down to a value of zero (0) for a data tenure of zero (0) or an absence of tenure data. The adjustments are performed by multiplying the input base score by a factor representative of the data tenure. For example, a data tenure of approximately three (3) years results in multiplication of the base score by a factor of 60% (three (3) years is 0.60 or 60% of five (5) years), for an effective reduction in the base score of approximately 40%. The adjustments for data tenure however are not limited to linear adjustments or multiplication operations.

The ranking component 104 also adjusts the base score according to data validity or verification. For example, the input base score, whether unadjusted or previously adjusted, is not adjusted for a fully verified account, but is adjusted down (e.g., reduced 50%, reduced 30%, etc.) for an unverified account. The adjustments for data validity are not limited to linear adjustments or multiplication operations.

The ranking component 104 can also adjust the base score according to member popularity. For example, the input base score, whether unadjusted or previously adjusted, is not adjusted for a contact and follower network larger than a pre-specified popularity threshold. However, the input base score can be adjusted down (e.g., reduced 25%) for an empty network with no linked members. For example, a network of a particular member that includes a number of members approximately equal to 80% of the popularity threshold value results in an effective reduction in the base score of approximately 10%. The adjustments for member popularity are not limited to linear adjustments or multiplication operations.

Following application of any adjustments to the base score, as appropriate to a member and the member's corresponding data, the resulting score is assigned to the member. The ranking component 104 uses the assigned score of members to “rank” 402 each member and compare each member against other members, individuals, and benchmarks. The ranking component 104 assesses the scores of the total member population and assigns each member to a group, where each group represents a percentile of the total member population. The ranking component 104 of an embodiment, for example, includes five groups into which a member is placed, the groups including elite members (top 1%), platinum members (top 2-10%), gold members (top 11-25%), silver members (top 26-50%), and bronze members (remaining). The ranking component 104 of alternative embodiments can include an alternative number of groups and/or alternative percentiles corresponding to the groups (e.g., decile groups, etc.).

The IDSS components use the member rankings 402 to “match” a member with other members who may share similar portfolio construction, holdings, risk level, investing strategies, and/or other demographics (e.g., age, zip code, education), and who may have significantly outperformed the member with lower incurred risk levels. By doing so, the IDSS greatly informs a particular member about the state of his/her investment approach and performance and potentially improves future returns for the member.

The IDSS also uses the ranking 402 to understand or provide information as to how different ranks of investors are making investment decisions. For example, the IDSS enables visibility into what the “top 10%” members are holding, investing in, watching, and/or transacting. Furthermore, the IDSS provides insight into the top aggregated holdings, watch list items, and buys and sells across each of the rank categories or groups. The IDSS enables tracking of certain securities over time to understand how a particular security (e.g., Apple Inc.) trends in “popularity” over time and identify when large blocks of individuals having a certain rank are trading. Therefore, while trading activity in the form of total volume of securities traded is publicly available information, the IDSS adds a component of information as to which investors (e.g., “good” or “bad” investors) are participating in the trading activity.

The member rankings 402 are also used as benchmarks by which each member can evaluate his/her performance against his/her appropriate benchmark using his/her portfolio components. For example, the rankings 402 serve to benchmark individual member performance against relevant market indices over the tenure of data, to benchmark individual return performance against other individuals, to benchmark individual return performance against an aggregate of individuals based upon ranked return performance and various demographic characteristics including, but not limited to, zip code, income level, investment strategies, education, professional affiliation, and social networks, to name a few.

The IDSS rankings 402 also provide “Instant Asset Allocation” benchmarks to peer rank groups. The IDSS allocates member positions into core asset categories and provides an asset allocation model. The IDSS therefore enables comparison of individual asset allocation with other peer rank groups. The IDSS also creates “best practices” asset allocation models based upon the top performance of individuals using holdings, risk exposure, beta, Sharpe and other relevant metrics. The IDSS of an embodiment uses or includes a proactive “Dynamic Asset Allocation” model by which users can set allocation parameters enabling the IDSS to automatically notify users when allocation parameters are violated.

The IDSS uses data of the investor rankings 402 to rate securities. The rating component 106 is configured to rate 602 publicly-traded equities, exchange-traded funds (ETFs), mutual funds, options, fixed income instruments, and/or other available investment vehicles based on the performance of the individuals that own, buy, and/or sell positions. For example, a member doing research on Apple Inc. can search the IDSS for information on the stock. The IDSS subscribes a rating 602 to the stock based on the number and quality of other members that currently own the stock, the number and quality of members that are shorting the stock, the number and quality of members that previously own the stock, and the relative performance of those members. Equities that have been recently purchased by aggregate top ranked members and/or equities that continue to be owned by top ranked members will receive relatively high ratings. Positions that have either been liquidated by top ranked performers and/or acquired primarily by lower ranked performers will receive relatively low ratings.

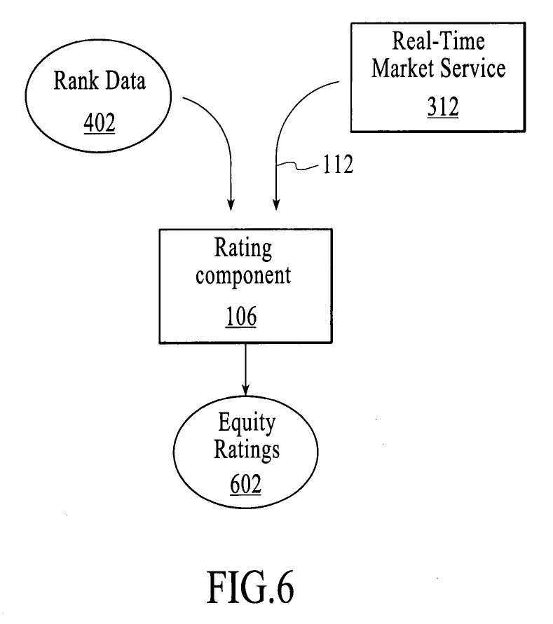

FIG. 6 is a block diagram of the rating component 106 of the IDSS configured to provide or output security ratings 602 in response to or as a result of operations on rank data 402 and real-time trade data 112, under an embodiment. The real-time trade data 112 can be received from one or more real-time market services 312 to which the rating component is coupled, but is not so limited.

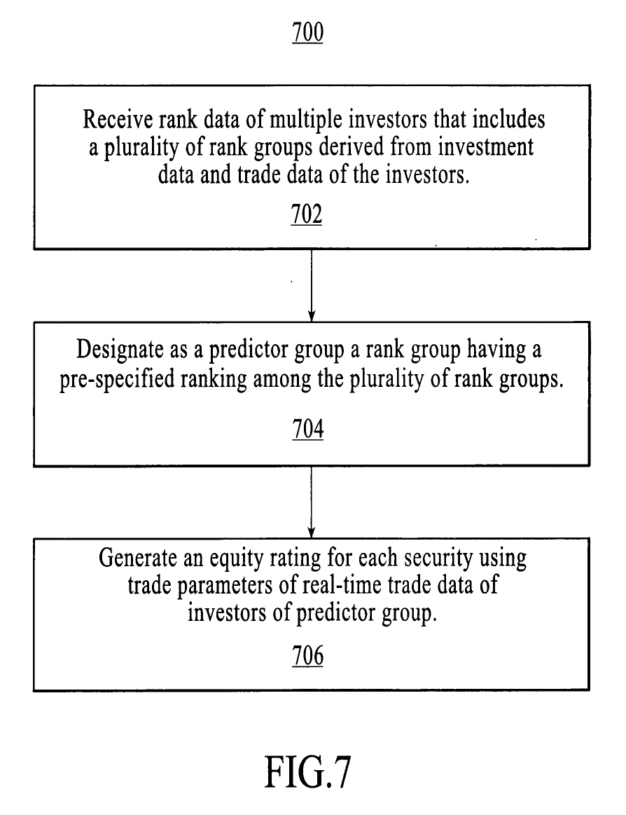

FIG. 7 is a flow diagram for rating equities 700 using the rating component 106 operating on rank data 402 and real-time trade data 112, under an embodiment. Components of the IDSS are generally configured and function to receive 702 rank data of the investors. The rank data includes rank groups derived from investment data and trade data of the investors. The IDSS uses all rank behavior and activity to generate ratings and, in so doing, sorts positions based on cumulative ownership, watch and transaction behavior and selects or designates 704 a rank group having a pre-specified ranking (e.g., the highest ranking, lowest ranking, etc.). The selected group is used as a predictor group. A security rating is generated 706 for each security using trade parameters of real-time trade data of investors of the predictor group.

Generally, the rating component 106 uses information of the member rankings 402 to generate security ratings 602. Similar to the Schwab Equity Rating System and Morningstar's mutual fund star rating system, the IDSS provides a proprietary rating for publicly-available securities; however, in contrast to these conventional systems, the basis for the IDSS security ratings 602 is the individual member rankings as described below. Additionally, other parameters (e.g., earnings per share (EPS), price-to-earnings (P/E) ratio, balance sheet strength, etc.) may be used along with the rank data to generate the security ratings. The security ratings 602 function to associate with each stock either a buy or a sell recommendation together with “strength of signal” indications of strength of the recommendation.

The IDSS evaluates activity of certain ranks of members in the aggregate to rate publicly-traded equities in real-time. The ratings 602 include the ratings A, B, C, D, and F, but alternative embodiments can use alternative scales or alternative gradations. The IDSS ratings component 106 is configured to sort or organize security positions based on the cumulative ownership, watch, and transaction behavior by rank. For example, movements in and out of positions by members of particular ranks 402 will be catalogued and analyzed (e.g., buys and sells by “Elite” and “Platinum” investors are likely more attractive buying opportunities for corresponding purchases by lower ranked investors). The rating component 106 is configured to also use publicly available financial data, such as fundamentals, valuation, earnings momentum, and risk, in the generation of ratings 602. The rating 602 of an embodiment is based on rank 402, with a principal focus on ownership and activity (e.g., buying, selling, retaining) of the members ranked at the top and bottom 10%, but is not so limited.

The rating component 106 evaluates strategies of the members to provide information on strategies that have worked previously and strategies likely to be successful in the future. For example, regression analysis can be applied to investment data to identify the core components that can lead to a predictive model of future out-performance for some period of time. The opposite is also true, whereby the rating component can determine investors and strategies that have been found to under-perform. An anti-fraud component provides fraud detection so that members are prevented from using the system to manipulate stocks, thereby affecting their performance and rating. The rating component 106 thus provides information of expected future performance of particular equities in the form of the security ratings 602. Consequently, the IDSS provides data and predictive information or models that, on average, is relatively more accurate than individual analysts at brokerage firms, mutual fund managers, and professional investment advisors.

The ratings 602 form the basis for comparisons across different positions. For example, the IDSS can track movements over time and compare how securities have trended over certain time horizons. The IDSS can compare individual members based on the “rating” 602 of positions in their portfolios. Other positions can be provided or displayed to a member, which may provide more significant upside with reduced risk than the ones currently in the member's portfolio. The IDSS can also “see” across various industry sectors and investing strategies to develop hypotheses around areas of potential out-performance and under-performance.

The IDSS of an embodiment is configured to display the ratings 602 to members via a portal (e.g., IDSS web site). A rating is displayed to correspond to each security or position in the member portfolios. The IDSS can also use filtering to display other securities that are related to a particular security but which have a higher “rating” than the particular security.

The security ratings are displayed using a “strength of signal” graphic or plot, for example. Because the rankings 402 generated by the IDSS assist members in better understanding the underlying positions that members of different ranks are holding, watching, and transacting, the IDSS uses the rankings 402 to generate information of and display via the strength of signal plot the “net buying” activity of particular positions through application of a calculation that aggregates all of the different rankings into one measure. The IDSS calculates this measure over time to determine an understanding of trends. This way, a member can compare various positions quickly to gauge whether he/she should sell or buy.

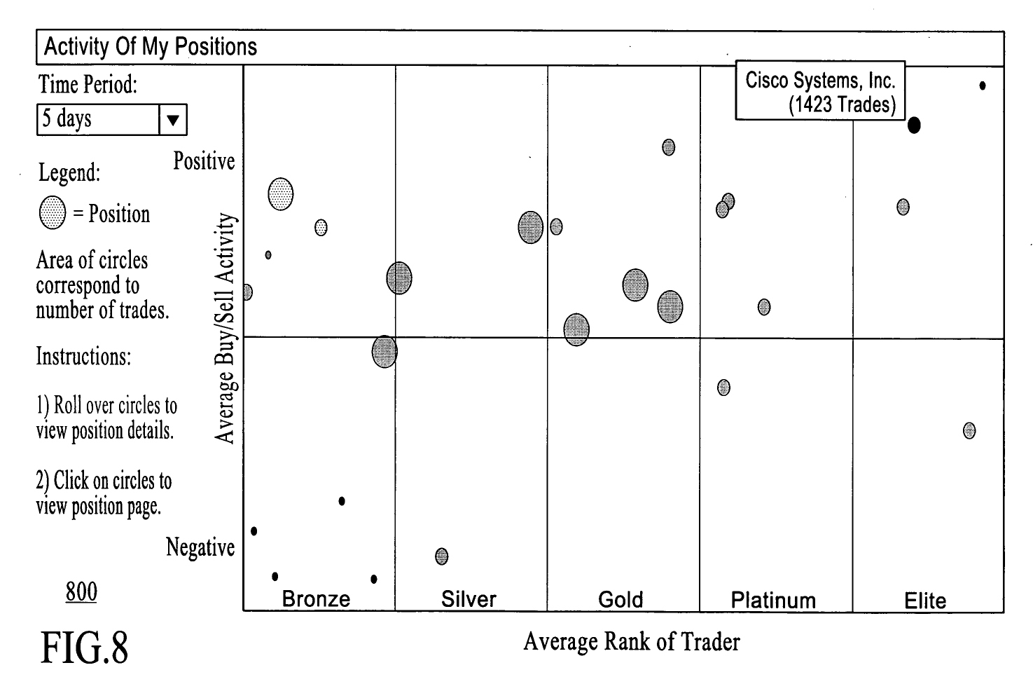

FIG. 8 is a strength of signal plot 800, under an embodiment. The IDSS calculates the strength of signal 800 over time to determine an understanding of trends, and the strength of signal measure is visually illustrated 802 in the strength of signal plot 800. The absolute value of the strength of signal value 802 indicates the strength of a security rating for the corresponding security, and the sign (position on y-axis relative to center-point) of the strength of signal value 802 indicates if it is rated as a buy or a sell (e.g., a positive strength of signal value indicates a buy and a negative strength of signal value indicates a sell). This enables a member to compare various publicly-traded securities quickly to determine whether he/she should sell or buy.

In generating strength of signal, the organizing of rank categories is done by scoring each category. The scoring includes determining the number of trades per rank category (e.g., elite, bronze, etc.), and weighting the number of trades of each rank category by the relative performance of that rank category compared to other categories. Therefore, the scoring includes determining a ratio for each category by dividing the average return for that category by the average return for the bronze category, where the performance of the bronze category serves as a base category in this example.

The categories are arranged along the x-axis of the strength of signal plot 800 according to their score (e.g., category with lowest score is placed in left-most position along the x-axis, category with highest score is placed in right-most position along the x-axis). Alternatively, securities can be placed on the strength of signal plot 800 without any express correlation to rank categories. Therefore, the IDSS generates the strength of signal plot 800 by identifying the category of members that provide the best performance (e.g., members with an Elite rank, members with a Platinum rank, etc.) and organizing the categories along the x-axis of a plot according to the relative performance. The x-axis of the plot of an embodiment thus provides an indication of which members are buying or selling a security.

The IDSS determines a number of buys and sells done for each security, and calculates the net transactions for each security by subtracting the number of sells from the number of buys for a period of time. The strength of signal measure 802 is determined by dividing the net transactions by the total number of buys and sells of the security. The y-axis of the strength of signal plot 800 therefore represents this average buy/sell activity (“net buy” or “net sell”), or strength of signal.

The strength of signal plot 800 of an embodiment provides information about which members have been buying a particular security over a certain time period. Using the strength of signal plot 800 as an example, a security located in the “top right” corner of the plot 800 means that top-ranked investors (e.g., Elite members in this example) have been buying this stock during the period, which might make this stock an attractive “buy” candidate for other members. Furthermore, an embodiment presents or displays the momentum of the strength of signal for a security over some period of time. The momentum includes information as to the difference in the size and placement of the circle over time but is not so limited.

The volume of trading for each security is represented by the size or area of the circle representing the security 802 on the plot 800. Consequently, the strength of signal plot 800 of an embodiment also provides information of the volume of trading for each security.

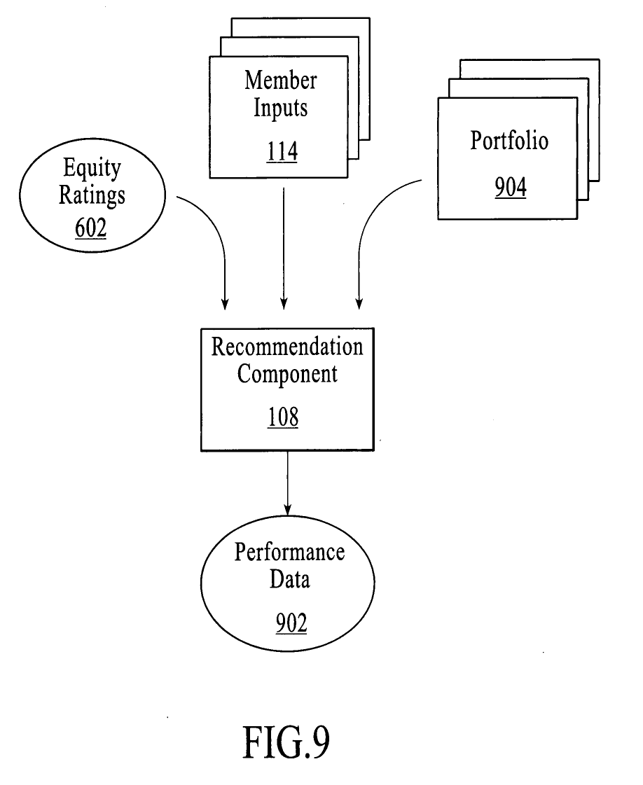

The IDSS uses the security ratings 602 along with portfolio data 904 of members to provide or output performance data 902 including investment recommendations to members, under an embodiment. FIG. 9 is a block diagram of the recommendation component 108 of the IDSS coupled to receive security rankings 602 and portfolio information or data 904, under an embodiment. The recommendation component 108 is generally configured to evaluate the security ratings 602 with risk level, asset allocation and stocks held by an investor, compare a set of members using the ranking and security ratings 602, and generate recommendations 902 for the stocks held by the member in response to the comparisons. The recommendations 902 include recommendations to certain investment vehicles based on the aggregate holdings of other individual members based on performance, demographic characteristics, and social networks.

Regarding recommendations, the IDSS recommendation component 108 uses the security rating data 602 to analyze each member's portfolio and to calculate and monitor performance measures so that a member is provided data on his/her portfolio returns, risk level, risk-adjusted performance and ranking. The recommendation component 108 uses data of a member's desired risk level (e.g., selected, entered 114 by the member or calculated by the system), asset allocation strategy and existing portfolio 904 and compares it with the security ratings, and provides recommendations 902 on which stocks to sell (e.g. sell F-rated stocks) and which to buy (e.g., buy A-rated or B-rated stock based on desired risk level).

The IDSS of an embodiment provides recommendations including an index for all or a subset of IDSS members, their portfolio holdings and performance for the purposes of measuring certain stock market performance. Similar to the Dow Jones Industrial Average, Russell 5000, and the Standard and Poor's 500 to name a few, the index, also referred to as the “individual investor index,” can provide relevant insights into the state of the stock market at a particular time. The index illustrates the relative performance of the IDSS members across various cross-sections of the IDSS membership, for example, all members, or across a group based on rank. The index can be based on member data like current holdings, positions bought, and/or positions sold, but is not so limited. The Index could be licensed to third parties who might be interested in the real-time and daily sentiment of the individual investing community.

As an example, the IDSS of an embodiment provides an index that is formed based on a member's holdings. The IDSS forms the index for a member by setting a starting index value (e.g., 100) on the first day of evaluation. The starting index value for purposes of this example is 100, but the starting index value is not limited to any particular value. A cross-section of the IDSS membership is selected for the index (e.g., Elite group). The IDSS then identifies the current holdings of the selected group. On the second day, the daily performance of the current (as selected at the end of the first day) holdings of the selected group is calculated as. The performance is based on the increase or decrease in value of the holdings from the market close of the first day to the market close of the second day, or in increments during the second day to provide intra-day/real-time values of the index. The daily performance forms a performance percentage (e.g., increase by 3%). The starting index value is adjusted by the performance percentage (e.g., the adjusted or new index value is 103 (100 multiplied by the quantity (1+0.03). Likewise, on the third day, the performance percentage of the end of second day holdings of the selected group is calculated based on their value during and at the end of the third day, and the index value of the second day is adjusted by the performance percentage. The index value adjustment proceeds on subsequent days as described above.

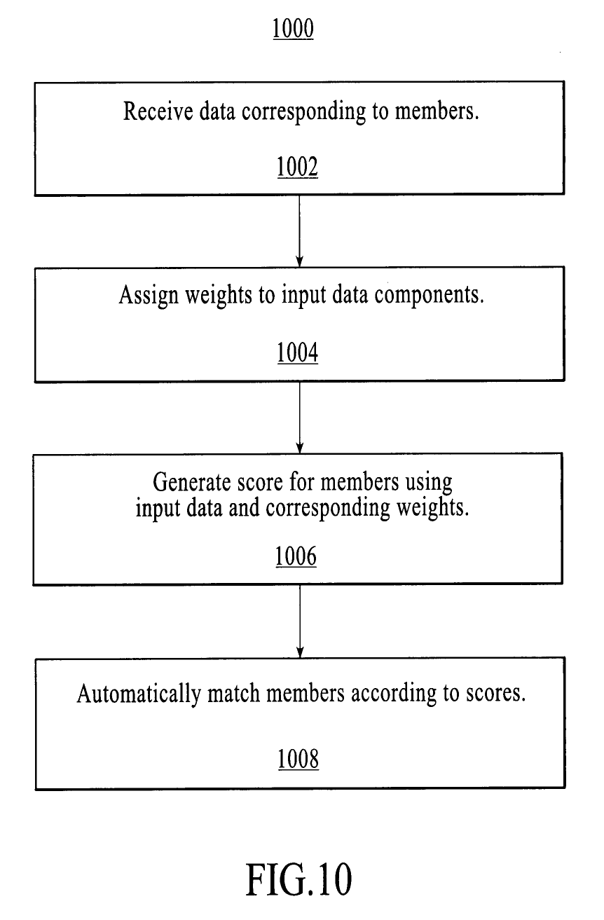

The IDSS of an embodiment enables member-investor matching in that it allows a member to identify other members with whom he/she has an investor relationship as measured by a pre-specified criteria. FIG. 10 is a flow diagram for investor matching 1000 using the IDSS, under an embodiment. Components of the IDSS receive data inputs corresponding to members. The data inputs include data of investment strategies, portfolio holdings, watch lists, transactions, performance and assorted demographic data, and other data as described above. Weights are assigned or selected for data components of the input data, and a score is generated for each member based on the input data and the corresponding weights. A member is automatically matched to other members according to his/her score. The matching is specific to criteria selected by the member requesting or controlling the matching. The results of the matching return information of members having the same score (within a pre-specified variance range) as the member requesting the match.

The matching is specific to criteria selected by the member requesting or controlling the matching, as described above. For example, when the criteria is investment approach, a member uses this criteria to control the matching based on how other members who share a similar investment approach are performing and what investments those other members are trading. The results of the match identify members having the same investment approach score (within a pre-specified variance range) as the member requesting the match. In this manner, a user can identify securities that he/she may be interested in adding to his/her portfolio.

The IDSS of an embodiment thus uses the ranking and rating data described above to provide real-time, automated, highly-customized investment “advice” to individual investors at a fraction of the cost of existing players. Leveraging the security rating described above, the IDSS provides or suggests improvements to a member's existing portfolio by suggesting changes to current asset allocation or substitutions to current allocation with less risky, higher-performing positions, explicitly based on a member's specific investment strategy. For example, if a member currently owns a stock that the IDSS rates as an “F”, the IDSS can suggest an alternative “A” rated position.

The IDSS of an embodiment provides electronic search capabilities to members for searching a database of member-investor information for the purposes of determining whether certain investment vehicles were previously or are currently held by other members. For example, a member can search for other members using data of a name, employer, holdings, performance, zip code, income levels, education, investing strategies, and professional and/or industry experience, to name a few.

The networking or linking of members provided by the IDSS also enables automated sharing of “authenticated” investment information with other members including, but not limited to, sharing of investment returns, holdings, such as portfolios, stock, bond, mutual fund, exchange traded funds, options, and other publicly available investment vehicles, as well as trading activity. As such, members can “allow” other members of the IDSS community to access relevant investment information.

The sharing of investment information further enables members to establish “private” Investment Clubs. An Investment Club is formed to include a set of members who share a common portfolio or investment vehicles. In contrast to ranking individual members, the IDSS of an embodiment is configured to apply the ranking techniques described above to the collective membership of each Investment Club in order to generate club rankings for each Investment Club. The club rankings can then be compared and/or used as described above in reference to individual member rankings.

The IDSS is also configured to enable members to “tag” the security holdings of certain other members to which they are linked for the purposes of easily and quickly monitoring their performance and progress. This can be done via a “My Profile” section of the IDSS website, for example, but is not so limited.

The IDSS enables a user to perform one or more of the following: “tag” a web page of an Internet web site; “add” an electronic link to a “My Profile” page of the IDSS web site; automatically distribute electronic links, news sources, and communications or messages via e-mail or instant messaging to members to whom the sending member is linked. As an example, a member reading a blog about Apple Inc. finds the article very informative as it mentions a new key feature that will allow Apple computers to run Windows. The user “tags” the URL of the blog posting or article and with one click “sends” the article to IDSS members that follow her portfolio.

The IDSS is configured to provide automated real-time trading activity notifications of individual member trading activity to other members. This allows members to set up an automated notification system, whereby they can view or be apprised of real-time buy and sell activity of other members. This can take the form of a personal “IDSS Stock Ticker” where positions of all or certain IDSS members are displayed, but is not so limited.

The IDSS enables automatic trading (auto-trade), for example, in response to the real-time disclosure of trading activity between linked investors. Consequently, the IDSS components can be configured to automatically mimic the trading activity (e.g. buying the same stock) of one member account in another account. Generally, a member (“follower member”) can “link” his account to another member's account (“mentor”). When the mentor buys stock in Apple Inc., any followers will automatically purchase the same number of shares in their accounts, assuming sufficient funds.

More specifically, a first member sells 100 shares of stock in Company X. Another member linked to the first member can configure her account to automatically sell 100 shares of stock in Company X in response to the real-time notification of the linked member's trade activity. The automatic trading activity in response to linked investor data includes automatic trading in third-party investment accounts (e.g., with third-party broker/dealers and/or registered investment advisers) and/or investment accounts provided on the platform.

The IDSS can be used to automate trading and/or provide additional trading and advisory products. For example, the IDSS could provide packaged solutions in the form of automated portfolio management in which a member pays an annual “advisory” fee and the IDSS maintains an asset allocation model customized for that member's investment goals. The IDSS could also offer investment products like mutual funds by certain sectors and investment strategies, thus creating a proprietary trading desk or IDSS mutual fund that seeks to capitalize on the IDSS aggregated data set through the inclusion of equities held by the highest ranked members, and selling shares in the mutual fund to the public. Additionally, the IDSS might provide a brokerage service including automatic trading.

Furthermore, the IDSS can be coupled or partner with online brokerage firms, who could add the IDSS to their proprietary system. Under this configuration, the IDSS would be an option within the online brokerage site so that account data is automatically populated. Also, the IDSS ranking system can be replicated within the partner environment to create a “mutual fund” of specific individuals that can be proprietary to specific partners.

Currently, there is no platform for professional investment managers to be “accredited” based upon their actual historical performance. The IDSS, however, provides a professional accreditation ranking system allowing an independent third party to “verify” performance of professionals. This is similar to other services like Better Business Bureau, BBB Online, Consumer Reports, and Good Housekeeping Seal of Approval, to name a few.

Conventional fee systems and the corresponding opaque mechanisms for extracting these fees, makes it difficult to hold investment advisors accountable for under-performance. Investment advisory service fees of the IDSS can be based on the actual delta improvement over a particular benchmark traced to the given advice, rather than on current industry practices of percentage of assets and/or flat fees. Thus, the IDSS includes a fee system under which a user pays nothing to the IDSS service if he/she fails to meet certain benchmarks, and pays a percentage of the incremental benefit of advice provided by or under the IDSS. Consequently, the IDSS establishes an “IDSS Universal Benchmark” from an amalgam of major indices which will serve as the benchmark for calculating fees on an annual basis. Under this system, if the “IDSS Universal Benchmark” was 4% for the year, and a user generated an 8% return, his/her fees would be some percentage of the 4% in incremental returns he/she generated presumably because of the IDSS.

The IDSS of an embodiment includes a method comprising aggregating investment data and real-time trade data of a plurality of investors. The method of an embodiment comprises ranking the plurality of investors according to investment performance derived from the investment data. The method of an embodiment comprises generating security ratings for securities held by the plurality of investors using the ranking and the trade data. The method of an embodiment comprises providing customized recommendations.

The investment data of an embodiment comprises data of current investment holdings, historical investment holdings, historical investment performance data, historical transactional data, and watch lists.

The real-time trade data of an embodiment includes trade data of the plurality of investors and trade data of at least one security market.

The equity ratings of an embodiment comprise a transaction recommendation and strength of signal indicator. The transaction recommendation of an embodiment includes a buy or sell recommendation for a corresponding security. The strength of signal indicator of an embodiment indicates strength of the transaction recommendation.

The method of an embodiment comprises automatically analyzing a portfolio of each of the plurality of investors using the security ratings. The method of an embodiment comprises generating performance measures for the portfolio.

Providing the customized recommendations of an embodiment comprises comparing the security ratings with risk level and securities held by an investor. Providing the customized recommendations of an embodiment comprises generating recommendations for the securities held by the investor in response to the comparing.

The method of an embodiment comprises generating an investor network by linking a first set of investors to a second set of investors. The link of an embodiment enables sharing of the investment data and trade data between the first and second set of investors. The plurality of investors of an embodiment includes the first and second set of investors.

The method of an embodiment comprises automatically performing a first security trade for a first investor in response to a second security trade by a second investor. The first investor of an embodiment is linked to the second investor.

The method of an embodiment comprises receiving one or more of the investment data and the trade data from a brokerage account of a third-party.

The aggregating of an embodiment comprises normalizing the investment data across one or more of at least one brokerage and at least one financial institution.

The normalizing of an embodiment comprises classifying transactions of the investment data and generating a transactional history of the investor. The normalizing of an embodiment comprises comparing current holdings of an investor with the transactional history. The normalizing of an embodiment comprises balancing the transactional history. The balancing of an embodiment augments the transactional history to match the current holdings.

The balancing of an embodiment comprises generating a synthetic sell transaction when the transactional history indicates cumulative security holdings that exceed the current holdings. The balancing of an embodiment comprises generating a synthetic buy transaction when the transactional history indicates the current holdings exceed the cumulative security holdings indicated by the transactional history.

Ranking the plurality of investors of an embodiment comprises generating a base score for each investor using the investment data.

Ranking the plurality of investors of an embodiment comprises generating an adjusted score for each investor by adjusting the base score according to a weighting parameter.

The weighting parameter of an embodiment includes at least one parameter selected from a group consisting of tenure of the investment data, verification state of the investment data, popularity of the investor relative to the plurality of investors, and momentum of the investor.

The method of an embodiment comprises assigning each investor to a rank group of a plurality of rank groups according to the adjusted score of the investor.

Ranking the plurality of investors of an embodiment comprises forming a plurality of clubs, wherein each club includes a set of the investors. Ranking the plurality of investors of an embodiment comprises assigning each of the plurality of clubs to one of a plurality of rank groups. The assigning of an embodiment is based on cumulative investment data of the set of the investors of the club.

Ranking the plurality of investors of an embodiment comprises generating a plurality of rank groups. Ranking the plurality of investors of an embodiment comprises assigning each of the plurality of investors to a rank group.

Generating equity ratings of an embodiment comprises selecting a rank group as a predictor group. Generating equity ratings of an embodiment comprises generating the security ratings using the investment data and trade data of the predictor group.

Generating equity ratings of an embodiment comprises organizing the securities based on the investment data. Generating equity ratings of an embodiment comprises generating a rating for each of the securities using holdings and transaction data of the real-time trade data.

The transaction data of an embodiment includes transaction type and transaction volume.

The method of an embodiment comprises generating comparisons of investors of the plurality of investors using the ranking and security ratings.

The IDSS of an embodiment includes a method comprising generating a network including links for sharing investment data and real-time trade data among a plurality of investors. The method of an embodiment comprises ranking the plurality of investors according to investment performance derived from the investment data and the trade data. The method of an embodiment comprises generating security ratings from the ranking. The method of an embodiment comprises generating recommendations for securities held by each investor using the security ratings.

The IDSS of an embodiment includes a system comprising an aggregation component coupled to a processor and configured to aggregate investment data and real-time trade data of a plurality of investors. The system of an embodiment comprises a ranking component coupled to the processor and configured to rank the plurality of investors according to investment performance and risk derived from the investment data. The system of an embodiment comprises a rating component coupled to the processor and configured to generate ratings for securities held by the plurality of investors using the ranking and the trade data.

The real-time trade data of an embodiment includes trade data of the plurality of investors and trade data of at least one securities market. The investment data of an embodiment comprises data of current investment holdings, historical investment holdings, historical investment performance data, historical transactional data, and watch lists.

The system of an embodiment comprises a recommendation component coupled to the processor and configured to evaluate the security ratings with risk level and investments held by an investor. The recommendation component of an embodiment is configured to compare a set of investors of the plurality of investors using the ranking and security ratings. The recommendation component of an embodiment is configured to generate recommendations for the investments held by the investor in response to the comparisons.

The system of an embodiment comprises a portal coupled to the processor. The portal of an embodiment is configured to allow each investor restricted access to shared data of the plurality of investors. The shared data of an embodiment includes one or more of the investment data, the real-time trade data, the rank, the security ratings, the recommendations, the performance measures, the evaluation, and the comparison.

The aggregation component of an embodiment is coupled to at least one brokerage account. The aggregation component of an embodiment is configured to receive one or more of the investment data and the trade data from the brokerage account.

The aggregation component of an embodiment is configured to normalize the investment data.

The normalizing of an embodiment includes classifying transactions of the investment data and generating a transactional history of the investor. The normalizing of an embodiment includes comparing current holdings of an investor with the transactional history. The normalizing of an embodiment includes balancing the transactional history. The balancing of an embodiment augments the transactional history to match the current holdings.

The ranking component of an embodiment is configured to rank the plurality of investors by generating a base score for each investor using the investment data. The ranking component of an embodiment is configured to generate an adjusted score for each investor by adjusting the base score according to a weighting parameter. The ranking component of an embodiment is configured to assign each investor to a rank group of a plurality of rank groups according to the adjusted score.

The weighting parameter of an embodiment is at least one parameter selected from a group consisting of average tenure of the investment data, verification state of the investment data, popularity of the investor relative to the plurality of investors, and momentum of the investor.

The rating component of an embodiment is configured to generate security ratings by selecting a rank group as a predictor group and generating the security ratings using the investment data and trade data of the predictor group.

The ranking component of an embodiment is configured to rank the plurality of investors by forming a plurality of clubs. Each club of an embodiment includes a set of the investors. The ranking component of an embodiment is configured to assign each of the plurality of clubs to one of a plurality of rank groups. The assigning of an embodiment is based on cumulative investment data of the set of the investors of the club.

The rating component of an embodiment is configured to generate a transaction recommendation and a strength of signal indicator. The transaction recommendation of an embodiment includes a buy or sell recommendation for a corresponding security. The strength of signal indicator of an embodiment indicates strength of the transaction recommendation.

The IDSS of an embodiment includes a computer readable medium comprising executable instructions which, when executed in a processing system, rates securities by aggregating investment data and real-time trade data of a plurality of investors. The instructions of an embodiment, when executed, rank the plurality of investors according to investment performance derived from the investment data. The instructions of an embodiment, when executed, generate security ratings for securities held by the plurality of investors using the ranking and the trade data.

The IDSS of an embodiment includes a method comprising aggregating investment data and real-time trade data of a plurality of investors. The method of an embodiment comprises generating a base score for each investor using the investment data. The method of an embodiment comprises generating an adjusted score for each investor by adjusting the base score according to a parameter selected from a group consisting of tenure of the investment data, verification state of the investment data, and popularity of the investor. The method of an embodiment comprises ranking investors by assigning each investor to a rank group according to the adjusted score of the investor.

The investment data of an embodiment comprises data of current investment holdings, historical investment holdings, historical investment performance data, historical transactional data, and watch lists.

The real-time trade data of an embodiment includes trade data of the plurality of investors and trade data of at least one security market.

Generating the base score of an embodiment comprises calculating a Sharpe Ratio as the base score.

Generating the adjusted score of an embodiment comprises adjusting the base score for the tenure.

Adjusting the base score of an embodiment for the tenure comprises reducing the base score in proportion to the tenure.

Generating the adjusted score of an embodiment comprises adjusting the base score for the verification state.

Adjusting the base score of an embodiment for the verification state comprises retaining the base score for data having a verified state and reducing the base score for data having an unverified state.

Generating the adjusted score of an embodiment comprises adjusting the base score for the popularity.

Adjusting the base score of an embodiment for the popularity comprises determining a size of a network of the investor. The network of an embodiment includes a set of investors of the plurality of investors to whom the investor is linked. Adjusting the base score of an embodiment for the popularity comprises reducing the base score when the size of the network is below a threshold value.

Generating the adjusted score of an embodiment comprises adjusting the base score for the tenure, the verification state, and the popularity.

The method of an embodiment comprises ordering the plurality of investors according to the adjusted score for each investor. The method of an embodiment comprises assigning a percentile to each investor that corresponds to the adjusted score of the investor relative to the adjusted scores of the plurality of investors.

The ranking of investors of an embodiment includes forming a plurality of rank groups according to assigned percentiles.

The ranking of investors of an embodiment includes forming a plurality of clubs. Each club of an embodiment includes a set of the investors. The ranking of investors of an embodiment includes assigning each of the plurality of clubs to a rank group based on cumulative investment data of the set of the investors of the club.

The method of an embodiment comprises generating an investor network by linking at least one set of investors of the plurality of investors. The link of an embodiment enables sharing of the investment data and trade data between linked investors.

The method of an embodiment comprises generating a transaction rating that includes a buy rating or sell rating for a security. The method of an embodiment comprises generating a strength of signal indicator that indicates strength of the transaction rating.

The method of an embodiment comprises generating equity ratings for securities held by the plurality of investors using the ranking and the trade data.

The method of an embodiment comprises automatically analyzing a portfolio of each of the plurality of investors using the equity ratings and generating performance measures for the portfolio.

The method of an embodiment comprises comparing the equity ratings with risk level and securities held by an investor. The method of an embodiment comprises generating recommendations for the securities held by the investor in response to the comparing.

Generating the equity ratings of an embodiment comprises selecting a rank group as a predictor group. Generating the equity ratings of an embodiment comprises generating the equity ratings using the investment data and trade data of the predictor group.

Generating the equity ratings of an embodiment comprises organizing securities held by the investors based on the investment data. Generating the equity ratings of an embodiment comprises generating the equity rating for each of the securities using transaction data of the real-time trade data.

The aggregating of an embodiment comprises normalizing the investment data. The normalizing of an embodiment comprises classifying transactions of the investment data and generating a transactional history of the investor. The normalizing of an embodiment comprises comparing current holdings of an investor with the transactional history. The normalizing of an embodiment comprises balancing the transactional history. The balancing of an embodiment augments the transactional history to match the current holdings.

The IDSS of an embodiment includes a method comprising aggregating investment data and real-time trade data of a plurality of investors. The method of an embodiment comprises generating a base score for each investor using the investment data. The method of an embodiment comprises generating an adjusted score by adjusting the base score according to at least one weighting parameter derived from the investment data and the trade data. The method of an embodiment comprises ranking investors according to the adjusted score.

The IDSS of an embodiment includes a system comprising an aggregation component coupled to a processor and configured to aggregate investment data and real-time trade data of a plurality of investors. The system of an embodiment comprises a ranking component coupled to the processor and configured to rank the plurality of investors according to investment performance derived from the investment data. The ranking component of an embodiment is configured to generate a base score for each investor using the investment data. The ranking component of an embodiment is configured to generate an adjusted score for each investor by adjusting the base score according to a parameter selected from a group consisting of tenure of the investment data, verification state of the investment data, and popularity of the investor. The ranking component of an embodiment is configured to rank investors by assigning each investor to a rank group according to the adjusted score of the investor.

The real-time trade data of an embodiment includes trade data of the plurality of investors and trade data of at least one security market. The investment data of an embodiment comprises data of current investment holdings, historical investment holdings, historical investment performance data, historical transactional data, and watch lists.

The system of an embodiment comprises a portal coupled to the processor. The portal of an embodiment is configured to allow each investor restricted access to shared data of the plurality of investors. The shared data of an embodiment includes the investment data. The shared data of an embodiment includes the real-time trade data. The shared data of an embodiment includes rank data.

The ranking component of an embodiment is configured to generate the base score by calculating a Sharpe Ratio as the base score.

The ranking component of an embodiment is configured to generate the adjusted score by adjusting the base score for the tenure.

Adjusting the base score of an embodiment for the tenure comprises reducing the base score in proportion to the tenure.

The ranking component of an embodiment is configured to generate the adjusted score by adjusting the base score for the verification state.

Adjusting the base score of an embodiment for the verification state comprises retaining the base score for data having a verified state and reducing the base score for data having an unverified state.

The ranking component of an embodiment is configured to generate the adjusted score by adjusting the base score for the popularity.

Adjusting the base score of an embodiment for the popularity comprises determining a size of a network of the investor. The network of an embodiment includes a set of investors of the plurality of investors to whom the investor is linked. Adjusting the base score of an embodiment for the popularity comprises reducing the base score when the size of the network is below a threshold value.

The ranking component of an embodiment is configured to generate the adjusted score by adjusting the base score for the tenure, the verification state, and the popularity.

The ranking component of an embodiment is configured to assign investors to a rank group by ordering the plurality of investors according to the adjusted score for each investor. The ranking component of an embodiment is configured to assign investors to a rank group by assigning a percentile to each investor that corresponds to the adjusted score of the investor relative to the adjusted scores of the plurality of investors. The ranking component of an embodiment is configured to assign investors to a rank group by forming a plurality of rank groups according to assigned percentiles.

The ranking component of an embodiment is configured to rank the plurality of investors by forming a plurality of clubs. Each club of an embodiment includes a set of the investors. The ranking component of an embodiment is configured to rank the plurality of investors by assigning each of the plurality of clubs to the rank group based on cumulative investment data of the set of the investors of the club.

The system of an embodiment comprises a rating component coupled to the processor and configured to generate equity ratings for securities held by the plurality of investors using the ranking and the trade data.

The rating component of an embodiment is configured to generate equity ratings by selecting a rank group as a predictor group and generating the equity ratings using the investment data and trade data of the predictor group.

The rating component of an embodiment is configured to generate a transaction recommendation and a strength of signal indicator. The transaction recommendation of an embodiment includes a buy or sell recommendation for a corresponding security. The strength of signal indicator of an embodiment indicates strength of the transaction recommendation.

The system of an embodiment comprises a recommendation component coupled to the processor and configured to evaluate the equity ratings with risk level and securities held by an investor. The recommendation component of an embodiment is configured to compare a set of investors of the plurality of investors using the ranking and equity ratings. The recommendation component of an embodiment is configured to generate recommendations for the securities held by the investor in response to the comparisons.

A computer readable medium comprising executable instructions which, when executed in a processing system, ranks investors by aggregating investment data and real-time trade data of a plurality of investors. The instructions of an embodiment, when executed, generate a base score for each investor using the investment data. The instructions of an embodiment, when executed, generate an adjusted score by adjusting the base score according to at least one weighting parameter derived from the investment data and the trade data. The instructions of an embodiment, when executed, rank investors according to the adjusted score.

The IDSS of an embodiment includes a method comprising receiving rank data of a plurality of investors that includes a plurality of rank groups derived from investment data and trade data of the plurality of investors. The method of an embodiment comprises designating as a predictor group a rank group of the plurality of rank groups. The method of an embodiment comprises generating an equity rating for each security of a plurality of securities using trade parameters of real-time trade data of investors of the predictor group.

The real-time trade data of an embodiment includes trade data of the plurality of investors and trade data of at least one security market. The investment data of an embodiment comprises data of current investment holdings, historical investment holdings, historical investment performance data, historical transactional data, and watch lists.

The trade parameters of an embodiment include transaction type and transaction volume.

The method of an embodiment comprises identifying transactions of the investment data and trade data involving the security.

The method of an embodiment comprises determining a number of buy transactions and a number of sell transactions involving the security.

The method of an embodiment comprises generating a total trade volume of the security.

Generating the equity rating of an embodiment for a security comprises generating a quantity by subtracting the number of sell transactions from the number of buy transactions. Generating the equity rating of an embodiment for a security comprises dividing the quantity by the total trade volume of the security.

The method of an embodiment comprises generating a transaction rating that includes a buy rating or sell rating for a security corresponding to the equity rating.

The method of an embodiment comprises generating a strength of signal indicator that indicates strength of the transaction rating.

The method of an embodiment comprises automatically analyzing a portfolio of each of the plurality of investors using the equity ratings. The method of an embodiment comprises generating, in response to the analyzing, performance measures for the portfolio and transaction recommendations for securities of the portfolio.

The method of an embodiment comprises generating the rank data by ranking the plurality of investors according to investment performance derived from the investment data.

Ranking the plurality of investors of an embodiment comprises generating a base score for each investor using the investment data. Ranking the plurality of investors of an embodiment comprises generating an adjusted score for each investor by adjusting the base score according to a weighting parameter.

The weighting parameter of an embodiment is at least one parameter selected from a group consisting of average annual return, risk, tenure of the investment data, verification state of the investment data, popularity of the investor relative to the plurality of investors, and momentum of the investor.

The method of an embodiment comprises assigning each investor to a rank group of the plurality of rank groups according to the adjusted score.

The method of an embodiment comprises generating the rank data by forming a plurality of clubs. Each club of an embodiment includes a set of the investors. The method of an embodiment comprises generating the rank data by assigning each of the plurality of clubs to one of a plurality of rank groups. The assigning of an embodiment is based on cumulative investment data of the set of the investors of the club.

The method of an embodiment comprises generating an investor network by linking at least one set of investors of the plurality of investors. The link of an embodiment enables sharing of the investment data and trade data between linked investors.

The method of an embodiment comprises normalizing the investment data.

The normalizing of an embodiment comprises classifying transactions of the investment data and generating a transactional history of the investor. The normalizing of an embodiment comprises comparing current holdings of an investor with the transactional history. The normalizing of an embodiment comprises balancing the transactional history, wherein the balancing manipulates the transactional history to match the current holdings.

The IDSS of an embodiment includes a system comprising a ranking component coupled to a processor and configured to generate rank data of a plurality of investors that includes a plurality of rank groups derived from investment data and real-time trade data of the plurality of investors. The system of an embodiment comprises a rating component coupled to the processor and configured to receive the rank data and designate as a predictor group a rank group having the highest ranking among the plurality of rank groups. The rating component of an embodiment is configured to generate an equity rating for each security using trade parameters of real-time trade data of investors of the predictor group.

The real-time trade data of an embodiment includes trade data of the plurality of investors and trade data of at least one security market. The investment data of an embodiment comprises data of current investment holdings, historical investment holdings, historical investment performance data, historical transactional data, and watch lists.

The system of an embodiment comprises an aggregation component coupled to the processor and configured to aggregate the investment data and the real-time trade data.

The trade parameters of an embodiment include transaction type and transaction volume.

The rating component of an embodiment is configured to identify transactions of the investment data and trade data involving the security.

The rating component of an embodiment is configured to determine a number of buy transactions and a number of sell transactions involving the security.

The rating component of an embodiment is configured to generate a total trade volume of the security.

The rating component of an embodiment is configured to generate a quantity by subtracting the number of sell transactions from the number of buy transactions, and dividing the quantity by the total trade volume of the security.

The rating component of an embodiment is configured to generate a transaction rating that includes a buy rating or sell rating for a security corresponding to the equity rating.

The rating component of an embodiment is configured to generate a strength of signal indicator. The strength of signal indicator of an embodiment indicates strength of the transaction rating.

The ranking component of an embodiment is configured to generate a base score for each investor using the investment data.

The ranking component of an embodiment is configured to generate an adjusted score for each investor by adjusting the base score according to a parameter selected from a group consisting of average annual return, risk, tenure of the investment data, verification state of the investment data, popularity of the investor relative to the plurality of investors, and momentum of the investor.

The ranking component of an embodiment is configured to rank investors by assigning each investor to a rank group according to the adjusted score of the investor.

The ranking component of an embodiment is configured to rank the plurality of investors by forming a plurality of clubs. Each club of an embodiment includes a set of the investors. The ranking component of an embodiment is configured to rank the plurality of investors by assigning each of the plurality of clubs to one of a plurality of rank groups. The assigning of an embodiment is based on cumulative investment data of the set of the investors of the club.

The system of an embodiment comprises a recommendation component coupled to the processor and configured to evaluate the equity ratings with risk level and securities held by an investor. The recommendation component of an embodiment is configured to compare a set of investors of the plurality of investors using the ranking and equity ratings. The recommendation component of an embodiment is configured to generate recommendations for the securities held by the investor in response to the comparisons.

The system of an embodiment comprises a portal coupled to the processor. The portal of an embodiment is configured to allow each investor restricted access to shared data of the plurality of investors. The shared data of an embodiment includes one or more of the investment data, the real-time trade data, and rank data.

The IDSS of an embodiment includes a computer readable medium comprising executable instructions which, when executed in a processing system, rates securities by receiving rank data of a plurality of investors that includes a plurality of rank groups derived from investment data and trade data of the plurality of investors. The instructions of an embodiment, when executed, designate as a predictor group a rank group having the highest ranking among the plurality of rank groups. The instructions of an embodiment, when executed, generate an equity rating for each security using trade parameters of real-time trade data of investors of the predictor group.

Aspects of the IDSS described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the IDSS include: microcontrollers with memory (such as electronically erasable programmable read only memory (EEPROM)), embedded microprocessors, firmware, software, etc. Furthermore, aspects of the IDSS may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the IDSS is not intended to be exhaustive or to limit the systems and methods to the precise forms disclosed. While specific embodiments of, and examples for, the IDSS are described herein for illustrative purposes, various equivalent modifications are possible within the scope of the systems and methods, as those skilled in the relevant art will recognize. The teachings of the IDSS provided herein can be applied to other systems and methods, not only for the systems and methods described above.

The elements and acts of the various embodiments described above can be combined to provide further embodiments. These and other changes can be made to the IDSS in light of the above detailed description.

In general, in the following claims, the terms used should not be construed to limit the IDSS to the specific embodiments disclosed in the specification and the claims, but should be construed to include all systems that operate under the claims. Accordingly, the IDSS is not limited by the disclosure, but instead the scope of the IDSS is to be determined entirely by the claims.

While certain aspects of the IDSS are presented below in certain claim forms, the inventors contemplate the various aspects of the IDSS in any number of claim forms.

Accordingly, the inventors reserve the right to add additional claims after filing the application to pursue such additional claim forms for other aspects of the IDSS.

What is claimed is:

1. A method comprising:
aggregating investment data and real-time trade data of a plurality of investors;
ranking the plurality of investors according to investment performance derived from the investment data;
generating security ratings for securities held by the plurality of investors using the ranking and the trade data; and
providing customized recommendations.

2. The method of claim 1, wherein the investment data comprises data of current investment holdings, historical investment holdings, historical investment performance data, historical transactional data, and watch lists.

3. The method of claim 1, wherein the real-time trade data includes trade data of the plurality of investors and trade data of at least one security market.

4. The method of claim 1, wherein the equity ratings comprise a transaction recommendation and strength of signal indicator, wherein the transaction recommendation includes a buy or sell recommendation for a corresponding security, wherein the strength of signal indicator indicates strength of the transaction recommendation.

5. The method of claim 1, comprising:
automatically analyzing a portfolio of each of the plurality of investors using the security ratings; and
generating performance measures for the portfolio.

6. The method of claim 1, wherein providing the customized recommendations comprises:
comparing the security ratings with risk level and securities held by an investor; and
generating recommendations for the securities held by the investor in response to the comparing.

7. The method of claim 1, comprising generating an investor network by linking a first set of investors to a second set of investors, wherein the link enables sharing of the investment data and trade data between the first and second set of investors, wherein the plurality of investors includes the first and second set of investors.

8. The method of claim 7, comprising automatically performing a first security trade for a first investor in response to a second security trade by a second investor, wherein the first investor is linked to the second investor.

9. The method of claim 1, comprising receiving one or more of the investment data and the trade data from a brokerage account of a third-party.

10. The method of claim 1, wherein the aggregating comprises normalizing the investment data across one or more of at least one brokerage and at least one financial institution.

11. The method of claim 10, wherein the normalizing comprises:
classifying transactions of the investment data and generating a transactional history of the investor;
comparing current holdings of an investor with the transactional history; and
balancing the transactional history, wherein the balancing augments the transactional history to match the current holdings.

12. The method of claim 11, wherein the balancing comprises:
generating a synthetic sell transaction when the transactional history indicates cumulative security holdings that exceed the current holdings; and
generating a synthetic buy transaction when the transactional history indicates the current holdings exceed the cumulative security holdings indicated by the transactional history.

13. The method of claim 1, wherein ranking the plurality of investors comprises generating a base score for each investor using the investment data.

14. The method of claim 13, wherein ranking the plurality of investors comprises generating an adjusted score for each investor by adjusting the base score according to a weighting parameter.

15. The method of claim 14, wherein the weighting parameter is at least one parameter selected from a group consisting of tenure of the investment data, verification state of the investment data, popularity of the investor relative to the plurality of investors, and momentum of the investor.

16. The method of claim 14, comprising assigning each investor to a rank group of a plurality of rank groups according to the adjusted score of the investor.

17. The method of claim 1, wherein ranking the plurality of investors comprises:
forming a plurality of clubs, wherein each club includes a set of the investors; and
assigning each of the plurality of clubs to one of a plurality of rank groups, the assigning based on cumulative investment data of the set of the investors of the club.

18. The method of claim 1, wherein ranking the plurality of investors comprises:
generating a plurality of rank groups; and
assigning each of the plurality of investors to a rank group.

19. The method of claim 18, wherein the generating of equity ratings comprises:
selecting a rank group as a predictor group;
generating the security ratings using the investment data and trade data of the predictor group.

20. The method of claim 1, wherein the generating of the equity ratings comprises:
organizing the securities based on the investment data; and
generating a rating for each of the securities using holdings and transaction data of the real-time trade data.

21. The method of claim 20, wherein the transaction data includes transaction type and transaction volume.

22. The method of claim 1, comprising generating comparisons of investors of the plurality of investors using the ranking and security ratings.

23. A method comprising:
generating a network including links for sharing investment data and real-time trade data among a plurality of investors;
ranking the plurality of investors according to investment performance derived from the investment data and the trade data;
generating security ratings from the ranking; and
generating recommendations for securities held by each investor using the security ratings.

24. A system comprising:
an aggregation component coupled to a processor and configured to aggregate investment data and real-time trade data of a plurality of investors;
a ranking component coupled to the processor and configured to rank the plurality of investors according to investment performance and risk derived from the investment data; and
a rating component coupled to the processor and configured to generate ratings for securities held by the plurality of investors using the ranking and the trade data.

25. The system of claim 24, wherein the real-time trade data includes trade data of the plurality of investors and trade data of at least one securities market, wherein the investment data comprises data of current investment holdings, historical investment holdings, historical investment performance data, historical transactional data, and watch lists.

26. The system of claim 24, comprising a recommendation component coupled to the processor and configured to evaluate the security ratings with risk level and investments held by an investor, compare a set of investors of the plurality of investors using the ranking and security ratings, and generate recommendations for the investments held by the investor in response to the comparisons.

27. The system of claim 26, comprising a portal coupled to the processor, the portal configured to allow each investor restricted access to shared data of the plurality of investors, wherein the shared data includes one or more of the investment data, the real-time trade data, the rank, the security ratings, the recommendations, the performance measures, the evaluation, and the comparison.

28. The system of claim 24, wherein the aggregation component is coupled to at least one brokerage account, wherein the aggregation component is configured to receive one or more of the investment data and the trade data from the brokerage account.

29. The system of claim 24, wherein the aggregation component is configured to normalize the investment data.

30. The system of claim 29, wherein the normalizing includes classifying transactions of the investment data and generating a transactional history of the investor, comparing current holdings of an investor with the transactional history, and balancing the transactional history, wherein the balancing augments the transactional history to match the current holdings.

31. The system of claim 24, wherein the ranking component is configured to rank the plurality of investors by generating a base score for each investor using the investment data, generating an adjusted score for each investor by adjusting the base score according to a weighting parameter, and assigning each investor to a rank group of a plurality of rank groups according to the adjusted score.

32. The system of claim 31, wherein the weighting parameter is at least one parameter selected from a group consisting of average tenure of the investment data, verification state of the investment data, popularity of the investor relative to the plurality of investors, and momentum of the investor.

33. The system of claim 31, wherein the rating component is configured to generate security ratings by selecting a rank group as a predictor group and generating the security ratings using the investment data and trade data of the predictor group.

34. The system of claim 24, wherein the ranking component is configured to rank the plurality of investors by forming a plurality of clubs, wherein each club includes a set of the investors, and assigning each of the plurality of clubs to one of a plurality of rank groups, the assigning based on cumulative investment data of the set of the investors of the club.

35. The system of claim 24, wherein the rating component is configured to generate a transaction recommendation and a strength of signal indicator, wherein the transaction recommendation includes a buy or sell recommendation for a corresponding security, wherein the strength of signal indicator indicates strength of the transaction recommendation.

36. A computer readable medium comprising executable instructions which, when executed in a processing system, rates securities by:
aggregating investment data and real-time trade data of a plurality of investors;
ranking the plurality of investors according to investment performance derived from the investment data; and
generating security ratings for securities held by the plurality of investors using the ranking and the trade data.
